(19) United States
(12) Patent Application Publication
(10) Pub. No.: US 2025/0153338 A1
(43) Pub. Date: May 15, 2025

(54) ADAPTABLE BRUSH HANDLE

(71) Applicants: Mitch Saccoccio, Hays, NC (US); Jonathan Bonelli, New York, NY (US)

(72) Inventors: Mitch Saccoccio, Hays, NC (US); Jonathan Bonelli, New York, NY (US)

(21) Appl. No.: 18/910,194

(22) Filed: Oct. 9, 2024

Related U.S. Application Data
(60) Provisional application No. 63/547,875, filed on Nov. 9, 2023.

(51) Int. Cl. B25G 1/04; B25G 3/18

(52) U.S. Cl. CPC B25G 1/04; B25G 3/18

(57) ABSTRACT

A versatile brush handle can be secured to a brush head, or used to couple additional handles of various sizes and configurations to the brush head.

### TECHNICAL FIELD

The present disclosure relates to a brush handle that can be adapted to fit other commonly used poles and devices of varying length and connection type.

### BACKGROUND OF THE INVENTION

Different types of brush handles have been available for quite some time. Typically, these brush handles come permanently attached to a tool and are adapted to fit a particular type of pole or are limited to use with a long pole. For example, a broom head with a female threaded insert that may be commonly used with a wooden male threaded pole, cannot be transferred to a telescopic pole that uses V-clip connections and is common to the pool industry.

Therefore, it is an object of the present invention to improve the versatility of the brush handle so that it may be adapted to various uses or used independently from a long pole.

### SUMMARY OF THE INVENTION

These and other advantages are explicitly provided by the present invention which is directed to a brush handle having a tubular main body, a connection at one end thereof for affixing to a brush, and separate connections for securing different-shaped handles thereto.

The present invention advantageously provides a simple, efficient brush handle that can be readily attached to a variety of common types of pole connections at one end, and many types of tool heads at another end. Moreover, the brush handle can also be used independently of a pole for use in closer proximity to the user. Additionally, a cap is provided for ease of storage.

### BRIEF DESCRIPTION OF THE DRAWINGS

The present invention will be described in greater detail with reference to the accompanying drawings, in which

FIG. 1 is a perspective view of the brush handle fully assembled,

FIG. 2 is an exploded perspective view of the brush handle,

FIG. 3 is a longitudinal sectional view of the brush handle along line 3-3 in FIG. 1,

FIG. 4 is a side elevational view of the brush handle,

FIG. 5 is a truncated perspective view of the brush handle with the cap removed and a male threaded pole connected to the brush handle.

FIG. 6 is a truncated perspective view of the brush handle with the cap removed and schematically illustrating attachment to a larger diameter pole,

FIG. 7 is a truncated perspective view of the brush handle and larger diameter pole attached to one another according to FIG. 6, and

FIG. 8 is a truncated perspective view of the brush handle with the cap inserted, and connected to a larger diameter pole.

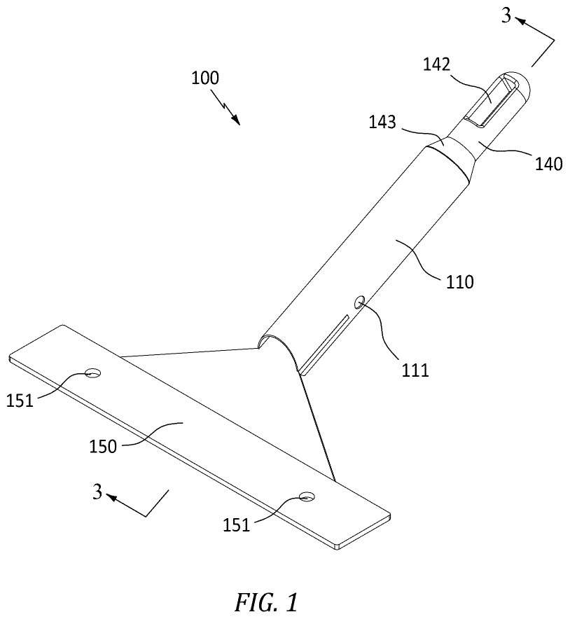

### DESCRIPTION OF THE PREFERRED EMBODIMENTS

Referring to the drawings, the brush handle 100 is constructed of a rigid material, preferably stainless steel and constructed as a cylindrically shaped, tubular main body 110. The main body 110 has two openings at opposite ends of the main body 110. Along the sides of the main body 110, are two radially-extending through-holes 111 diametrically opposite one another that form the locking openings for securing a larger diameter object, such as a common telescoping pole used in the pool industry, to the main body 110. The present invention is not limited to only two opposite locking openings 111, but any number of locking openings can be provided along the main body to secure different poles at different locations. Within the main body 110, a V-clip 120 is inserted with tips 121 thereof outwardly biased to seat with the respective locking openings 111, and further engages and aids attachment to a larger diameter pole 300. Although a V-clip 120 is depicted, other means of attachment are contemplated such as a rod that laterally passes through both the larger diameter pole 300 and the locking openings and is secured in place. The main body 110 may also be adapted to fit large diameter objects by use with a twist lock along the main body 110.

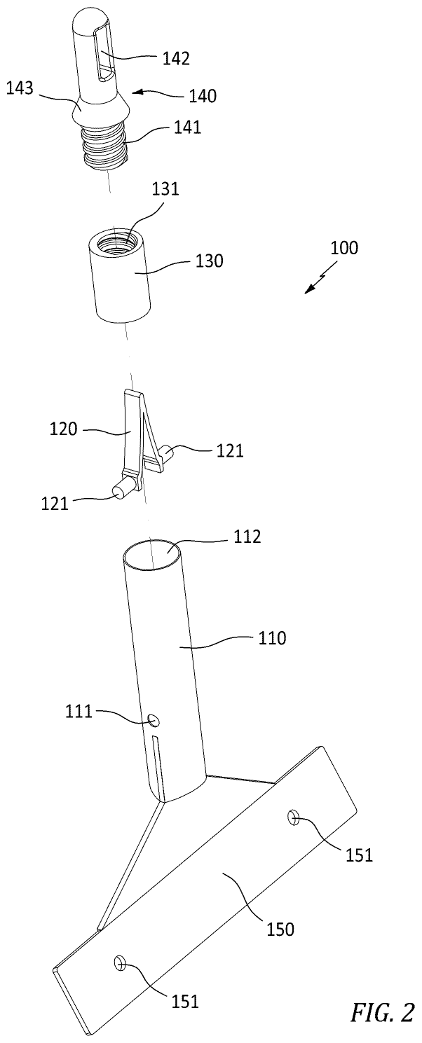

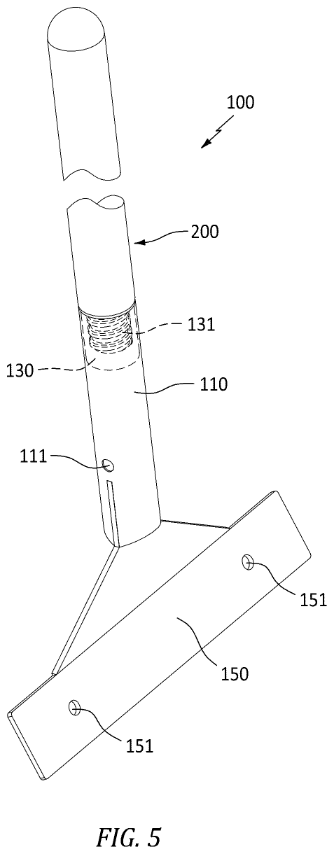

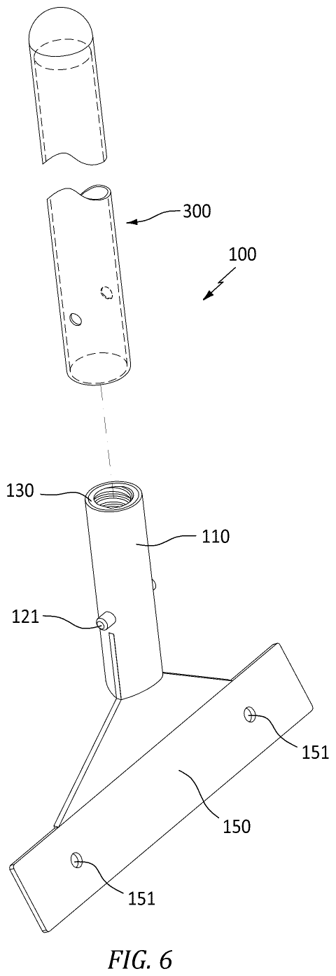

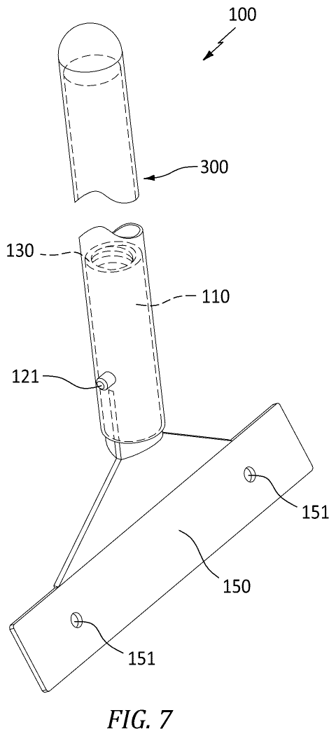

Referring to FIG. 2-8, at one end opening 112 of the main body 110, an adapter collar 130 can be press fit into the main body 110, although other means of attachment, such as a permanent weld, are contemplated (alternatively, the adapter collar 130 can be totally omitted). The adapter collar 130 contains a female threaded end 131 adapted for receiving a standard male threaded connection from a pole 200, as seen in FIG. 5. Common types of poles with this connection are extension poles, gardening poles, mop handles, and broom handles, although the present invention is not limited to specific types of poles but any pole having a male threaded connection can engage the adapter collar 130.

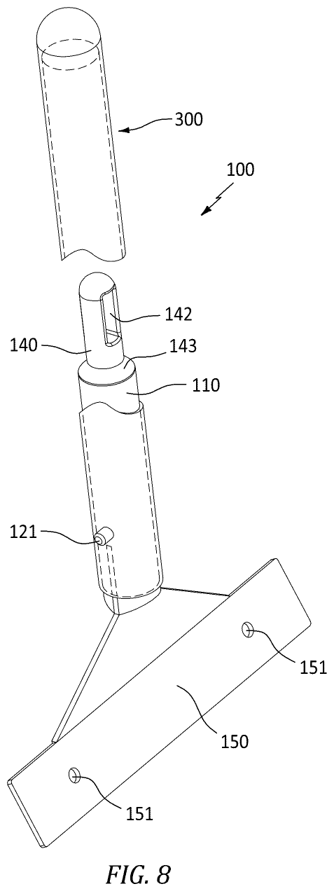

When a male-threaded pole 200 is not inserted in the adapter collar 130, a cap 140 may be inserted for storage and use as a shorter brush handle 100. The cap 140 has a male threaded connection 141 at the bottom thereof to screw into the female threads 131 of the adapter collar 130 and a clip having a through-hole 142 at the top end and which can be hung on a hook when not in use. The cap 140 has a flared midsection 143 which, at its widest point, is flush with the main body 110 as shown, e.g., in FIG. 8. The cap 140 can remain attached to the brush handle 100 when in use with a larger diameter pole that is attached via the locking openings 111, as seen in FIG. 8.

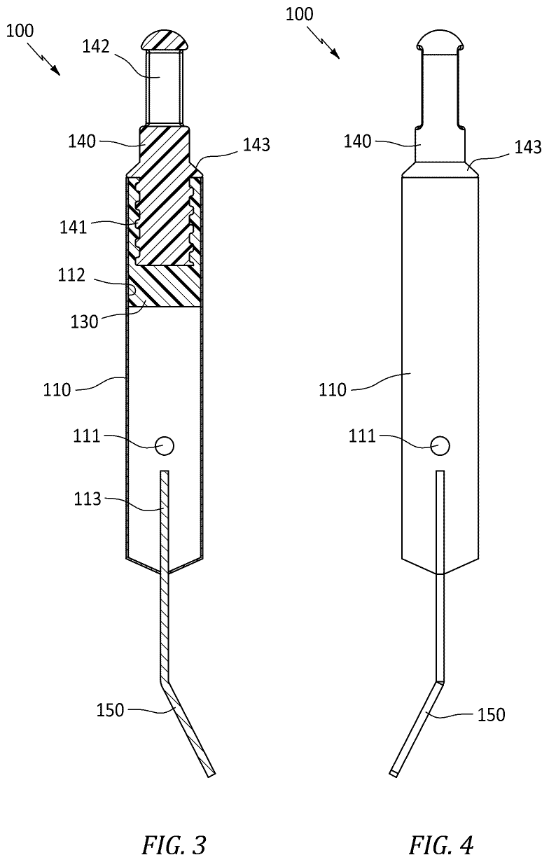

Opposite the adapter collar 130, an affixing plate 150 is attached to the main body 110 at the axially-extending, diametrically-opposite slots 113. The preferred embodiment illustrates a rigid affixing plate 150 permanently attached to the main body 110, e.g., by welding, and ergonomically fixed at an angle, although other angles, or an affixing plate capable of being adjusted to different angles, are contemplated. In the present embodiment, the affixing plate 150 is enclosed by the tubular main body 110 and axially-extending slots 113, as seen in FIGS. 3 and 4, with the affixing plate 150 inserted partway into the main body 110. The affixing plate 150 has two holes 151 positioned to be affixed to a number of different tools. While the present embodiment depicts an adaptable affixing plate 150, any number of tools can be permanently attached to the main body 110. Further, the affixing plate 150 is not limited to being welded to the body, as other means of attaching the affixing plate 150 or different tools are contemplated, such as providing another adapter collar 130.

The preceding description of the present invention is merely exemplary and not intended to limit the scope thereof.

What is claimed is:

1. A brush handle comprising
a tubular main body,
means positioned at one end of said tubular main body for affixing to a brush, and
separate first and second means for securing different-shaped handles thereto.

2. The handle of claim 1, additionally comprising a cap configured to seat on an end of said main body opposite said affixing means.

3. The handle of claim 1, wherein said tubular main body additionally comprises diametrically-opposite, axially-extending slots at one end thereof, and
said affixing means comprise a plate configured to be affixed to a brush,
said plate comprising an affixing portion to the brush, and an angled portion bent at an angle to said affixing portion, and
said angled portion configured to complementarily seat in said axially-extending slots of said tubular main body.

4. The handle of claim 3, wherein edges of said angled portion of said plate extend towards one another in a direction away from said affixing portion and terminate in an end of said plate having parallel edges remote from said affixing portion.

5. The handle of claim 4, wherein said end of said plate having said parallel edges is configured to be welded in said diametrically-opposite axially-extending slots.

6. The handle of claim 1, wherein one of said separate first and second securing means comprise
diametrically-opposite, radially-extending through-holes in said tubular main body, and
a resilient V-shaped clip configured to seat within said tubular main body with tips thereof biased to protrude through said respective diametrically-opposite, radially-extending through-holes.

7. The handle of claim 1, wherein one of said first and second securing means comprise an internally female threaded end of said tubular main body opposite said affixing means.

8. The handle of claim 7, additionally comprising a cap having a male-threaded end and configured to screw into said female threaded end of said tubular main body.

9. The handle of claim 8, wherein said cap additionally comprises a clip having a through-hole and at end opposite said male-threaded end thereof.

10. The handle of claim 7, wherein one of said separate first and second securing means comprise
an internally-female threaded collar configured to be secured within an end of said tubular main body opposite said affixing means and form said internally-female threaded end of said tubular body.

11. The handle of claim 10, wherein said collar is configured to be force fit into said end of said tubular main body.

12. The handle of claim 1, wherein said first securing means comprise either
(1) an internally female threaded end of said tubular main body opposite said affixing means, or
(2) an internally-female threaded collar configured to be secured within the end of said tubular main body opposite said affixing means, and
said second securing means comprise
diametrically-opposite, radially-extending through-holes through said tubular main body, and
a resilient V-shaped clip configured to seat within said tubular main body with tips thereof biased to protrude through said respective diametrically-opposite, radially-extending through-holes.

13. The handle of claim 12, wherein said tubular main body additionally comprises diametrically-opposite, axially-extending slots at one end thereof, and
said affixing means comprise a plate configured to be affixed to a brush,
said plate comprising an affixing portion to the brush, and an angled portion bent at an angle to said affixing portion, and
said angled portion configured to complementarily seat in said axially-extending slots of said tubular main body.
